(19) United States
(12) Patent Application Publication
(10) Pub. No.: US 2021/0035062 A1
(43) Pub. Date: Feb. 4, 2021

(54) INFORMATION PROMPT

(71) Applicant: Beijing Sankuai Online Technology Co., Ltd, Beijing (CN)

(72) Inventors: Ke XING, Beijing (CN); Chaoyi MA, Beijing (CN)

(21) Appl. No.: 16/964,099

(22) PCT Filed: Nov. 16, 2018
(86) PCT No.: PCT/CN2018/115818

§ 371 Date: Jul. 22, 2020

(30) Foreign Application Priority Data
Feb. 5, 2018 (CN) 201810111466.7

(51) Int. Cl. G06Q 10/08; G06Q 30/06

(52) U.S. Cl. CPC G06Q 10/0835; G06Q 30/0635; G06Q 10/0838

(57) ABSTRACT

An information prompt method and apparatus and an electronic device are provided. The information prompt method includes: monitoring whether a target delivery order meets a preset activation condition (S101); obtaining, when the target delivery order meets the preset activation condition, auxiliary information corresponding to an order identifier of the target delivery order (S102), where the auxiliary information is determined based on an advance contact probability corresponding to the order identifier, the advance contact probability is determined based on a target historical order, and the target historical order is a historical order with the order identifier; and outputting prompt information when the auxiliary information meets a preset prompt condition (S103).

### CROSS-REFERENCE TO RELATED APPLICATIONS

This patent application claims priority to Chinese Patent Application No. 201810111466.7, filed on Feb. 5, 2018 and entitled “INFORMATION PROMPT METHOD AND APPARATUS, AND ELECTRONIC DEVICE”, which is incorporated herein by reference in its entirety.

### TECHNICAL FIELD

This application relates to the field of information processing, and in particular, to an information prompt method and apparatus, and an electronic device.

### BACKGROUND

In a logistics delivery process, for some scenarios in which access control exists at a user's location (office building, a community with a security guard) or the user is absent or the like, a deliverer needs to contact the user in advance to ensure delivery efficiency.

The deliverer generally analyzes the scenario subjectively to determine whether to contact the user in advance, and contacts the user to learn information such as a specific delivery location or learn whether the user is at home. The subjective analysis is entirely based on experience, and leads to low reliability of a judgment result and brings great inconvenience to a delivery process of the deliverer. Especially for inexperienced deliverers or those who are experienced but not familiar with surroundings, the inconvenience is more obvious.

### SUMMARY

In view of the foregoing background, embodiments of this application provide an information prompt method and apparatus, and an electronic device to improve reliability of a judgment result of determining whether to contact a user in advance, and improve convenience in a delivery process.

Specifically, this application is implemented through the following technical solutions:

According to a first aspect, an embodiment of this application provides an information prompt method, including:

monitoring whether a target delivery order meets a preset activation condition;

obtaining, when the target delivery order meets the preset activation condition, auxiliary information corresponding to an order identifier of the target delivery order, where the auxiliary information is determined based on an advance contact probability corresponding to the order identifier; and

outputting prompt information when the auxiliary information meets a preset prompt condition.

In an example, the advance contact probability is determined based on a target historical order, and the target historical order is a historical order with the order identifier.

Optionally, when the auxiliary information is the advance contact probability, the step of outputting prompt information when the auxiliary information meets a preset prompt condition includes:

outputting the prompt information when the advance contact probability is greater than a preset probability threshold.

When the auxiliary information is a judgment result determined based on the advance contact probability, the step of outputting prompt information when the auxiliary information meets a preset prompt condition includes:

outputting the prompt information when the judgment result indicates a need to contact the user in advance.

When the auxiliary information is the advance contact probability and a judgment result determined based on the advance contact probability, the step of outputting prompt information when the auxiliary information meets a preset prompt condition includes:

outputting the prompt information when the advance contact probability is greater than the preset probability threshold or when the judgment result indicates a need to contact the user in advance.

Optionally, the preset activation condition is: a delivery status is a state indicating that a deliverer is heading to the user's location, or an instruction of obtaining prompt information about the target delivery order is received.

Optionally, the step of obtaining auxiliary information corresponding to an order identifier of the target delivery order includes:

obtaining auxiliary information corresponding to a delivery address of the target delivery order.

Optionally, a formula for calculating the advance contact probability is:

$${P}_{i} = \frac{\frac{freq ( {y}_{i} \vert X )}{freq ( X )} \frac{freq ( X )}{freq ( All )}}{P ( Y = {y}_{i} )}$$

where Pᵢ is an advance contact probability corresponding to a delivery order that has a delivery address i, freq(yᵢ|X) is a quantity of samples that have a record of contacting a user in advance of delivery and that have a delivery address i, freq(X) is a quantity of samples that have a record of contacting a user in advance of delivery among all historical order samples, freq(All) is a quantity of all historical order samples, and P(Y=yᵢ) is a probability of historical order samples with a delivery address i existing in all the historical order samples.

Optionally, the step of obtaining auxiliary information corresponding to an order identifier of the target delivery order includes:

obtaining auxiliary information corresponding to a user identifier of the target delivery order.

Optionally, a formula for calculating the advance contact probability is:

$${P}_{i} = \frac{\frac{freq ( {z}_{i} \vert X )}{freq ( X )} \frac{freq ( X )}{freq ( All )}}{P ( Z = {z}_{i} )}$$

where Pᵢ is an advance contact probability corresponding to a delivery order that has a user identifier i, freq(z₁|X) is a quantity of samples that have a record of contacting a user in advance of delivery and that have a user identifier i, freq(X) is a quantity of samples that have a record of contacting a user in advance of delivery among all historical order samples, freq(All) is a quantity of all historical order samples, and P(Z=z₁) is a probability of historical order samples with a user identifier i existing in all the historical order samples.

Optionally, means of contact corresponding to the advance contact probability include: telephone, short message service, instant messaging (IM), or one or more thereof.

Optionally, after outputting the prompt information, the method further includes:

obtaining a historical interaction time corresponding to the order identifier, where the historical interaction time is an average time required from contacting the user to completing delivery of the delivery order;

calculating, based on the obtained historical interaction time and a riding speed of the deliverer, a distance threshold for the deliverer to contact the user in advance; and

prompting, when detecting that a distance between the deliverer and a delivery address in the target delivery order is lower than the distance threshold, the deliverer to contact a user in the target delivery order.

Optionally, after the step of prompting the deliverer to contact the user in the target delivery order, the method further includes:

obtaining a speech instruction issued by the deliverer; and

performing, when it is determined that the speech instruction is a preset contact instruction, an operation of contacting the user in the target delivery order.

According to a second aspect, an embodiment of this application provides an information prompt apparatus, including:

a monitoring unit, configured to monitor whether a target delivery order meets a preset activation condition;

an auxiliary information obtaining unit, configured to obtain, when the target delivery order meets the preset activation condition, auxiliary information corresponding to an order identifier of the target delivery order, where the auxiliary information is determined based on an advance contact probability corresponding to the order identifier, the advance contact probability is determined based on a target historical order, and the target historical order is a historical order with the order identifier; and

a prompt information output unit, configured to output prompt information when the auxiliary information meets a preset prompt condition.

Optionally, the prompt information output unit includes:

a first information output subunit, configured to output the prompt information when the auxiliary information is the advance contact probability and when the advance contact probability is greater than a preset probability threshold;

or,

a second information output subunit, configured to output the prompt information when the auxiliary information is a judgment result determined based on the advance contact probability and when the judgment result indicates a need to contact the user in advance;

or,

a third information output subunit, configured to output the prompt information when the auxiliary information is the advance contact probability and a judgment result determined based on the advance contact probability and when the advance contact probability is greater than a preset probability threshold or the judgment result indicates a need to contact the user in advance.

Optionally, the auxiliary information obtaining unit includes:

a first information obtaining subunit, configured to obtain, when the target delivery order meets the preset activation condition, auxiliary information corresponding to a delivery address of the target delivery order.

Optionally, the auxiliary information obtaining unit includes:

a second information obtaining subunit, configured to obtain, when the target delivery order meets the preset activation condition, auxiliary information corresponding to a user identifier of the target delivery order.

Optionally, an information prompt apparatus according to an embodiment of this application further includes:

a historical interaction time obtaining unit, configured to obtain a historical interaction time corresponding to the order identifier after the prompt information output unit outputs the prompt information, where the historical interaction time is an average time required from contacting the user to completing delivery of the delivery order;

a distance threshold calculation unit, configured to calculate, based on the obtained historical interaction time and a riding speed of the deliverer, a distance threshold for the deliverer to contact the user in advance; and

a prompt unit, configured to prompt, when detecting that a distance between the deliverer and a delivery address in the target delivery order is lower than the distance threshold, the deliverer to contact a user in the target delivery order.

Optionally, an information prompt apparatus according to an embodiment of this application further includes:

a speech instruction collection unit, configured to obtain, after the prompt unit prompts the deliverer to contact the user in the target delivery order, a speech instruction issued by the deliverer; and

a contact operation performing unit, configured to perform, when it is determined that the speech instruction is a preset contact instruction, an operation of contacting the user in the target delivery order.

According to a third aspect, an electronic device according to an embodiment of this application includes a storage medium, a processor, and a computer program stored in the storage memory and executable on the processor. When executing the program, the processor implements the information prompt method according to the first aspect.

According to a fourth aspect, an embodiment of this application provides a computer-readable storage medium. The storage medium stores a computer program. The computer program is used to perform the information prompt method according to the first aspect.

In the information prompt method according to the embodiments of this application, the judgment result of determining whether to contact the user in advance is obtained based on historical data of the user, without requiring subjective analysis of the deliverer. Therefore, the judgment result is more credible and avoids an analysis process of the deliverer. As can be seen, this solution improves reliability of the judgment result of whether to contact the user in advance and convenience of the delivery process.

### BRIEF DESCRIPTION OF THE DRAWINGS

FIG. 1 is a flowchart of an information prompt method according to an embodiment of this application;

FIG. 2 is another flowchart of an information prompt method according to an embodiment of this application;

FIG. 3 is another flowchart of an information prompt method according to an embodiment of this application;

FIG. 4 is a schematic structural diagram of an information prompt apparatus according to an embodiment of this application;

FIG. 5 is another schematic structural diagram of an information prompt apparatus according to an embodiment of this application; and

FIG. 6 is a schematic structural diagram of an electronic device according to an embodiment of this application.

### DETAILED DESCRIPTION

Exemplary embodiments are described in detail herein, and examples of the exemplary embodiments are shown in the accompanying drawings. When the following descriptions are made with reference to the accompanying drawings, unless indicated otherwise, same numbers in different accompanying drawings represent same or similar elements. The following implementations described in the following exemplary embodiments do not represent all implementations that are consistent with this application. On the contrary, the implementations are merely examples of apparatuses and methods that are described in detail in the appended claims and that are consistent with some aspects of this application.

The terms used in this application are merely for the purpose of describing specific embodiments, and are not intended to limit this application. The terms “a”, “said” and “the” of singular forms used in this application and the appended claims are also intended to include plural forms, unless otherwise specified in the context clearly. It should also be understood that, the term “and/or” used herein indicates and includes any or all possible combinations of one or more associated listed items.

It should be understood that although the terms such as first, second, and third may be used herein to describe various information, such information should not be limited to these terms. These terms are merely used for distinguishing information of the same type from each other. For example, within the scope of this application, first information may also be referred to as second information, and similarly, second information may also be referred to as first information. Depending on the context, the term “if” as used herein may be interpreted as “when . . . ” or “upon . . . ” or “in response to determining.”

To improve reliability of a judgment result of determining whether to contact a user in advance during logistics delivery and improve convenience in a delivery process, embodiments of this application provide an information prompt method and apparatus, and an electronic device.

The following describes an information prompt method according to an embodiment of this application first.

It should be noted that the information prompt method according to the embodiment of this application may be implemented by an information prompt apparatus. The information prompt apparatus may run on a terminal device or a server.

In a specific application, when the information prompt apparatus runs on a terminal device, the information prompt apparatus may be a plug-in in delivery service client software, or a program that is independent of the delivery service client software but communicates with the delivery service client software. The delivery service client software is client software that runs on a terminal device of a deliverer and that is designed for a delivery service. When the information prompt apparatus runs on a server, the information prompt apparatus may be a plug-in in delivery service server software, or a program that is independent of the delivery service server software but communicates with the delivery service server software. All such practices are reasonable. For example, for food delivery, when the information prompt apparatus is applied to a terminal device, the information prompt apparatus may be a plug-in in food delivery client software, or a program that is independent of the food delivery client software but communicates with the food delivery client software. When the information prompt apparatus is applied to a server, the information prompt apparatus may be a plug-in in food delivery server software, or a program that is independent of the food delivery server software but communicates with the food delivery server software.

In addition, understandably, delivery services relating to the embodiments of this application may include, but are not limited to, food delivery and express delivery. In addition, means of contact applicable to contacting the user in advance in the embodiments of this application may include but without limitation: telephone, short message service, instant messaging (IM), or one or more thereof. The application scenario of contacting the user through an IM message may be a scenario in which the delivery service client software has an instant messaging function. That is, the deliverer can perform instant communication with the user through delivery service client software.

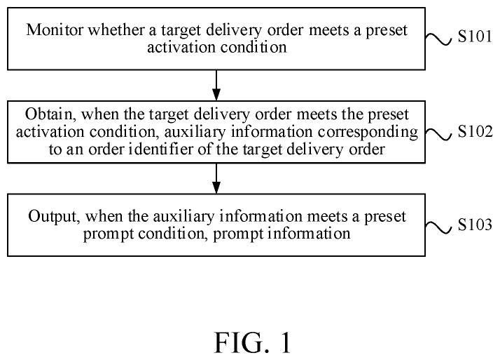

As shown in FIG. 1, an embodiment of this application provides an information prompt method, which may include the following steps:

S101. Monitor whether a target delivery order meets a preset activation condition.

In the embodiment of this application, the information prompt apparatus can monitor whether the target delivery order meets the preset activation condition, so as to send a prompt to the deliverer at a preset time to indicate whether to contact the user in advance. Any delivery order may be used as a target delivery order to undergo the information prompt method according to the embodiment of this application.

Optionally, to cater to delivery needs of most deliverers, in a specific implementation, the preset activation condition may be: a delivery status is a state indicating that the deliverer is heading to the user's location (hereinafter referred to as “heading state”). That is, when the delivery status of the target delivery order changes to the heading state, it indicates that the target delivery order meets the preset activation condition. Specifically, when the information prompt apparatus runs on a terminal device, the information prompt apparatus can directly monitor the delivery status of the target delivery order. When the delivery status of the target delivery order is detected as a heading state, it is determined that the target delivery order meets the preset activation condition. When the information prompt apparatus is applied to a server, the information prompt apparatus can obtain the delivery status of the target delivery order reported by the terminal device. When the obtained delivery status is the heading state, it is determined that the target delivery order meets the preset activation condition. The specific form of the heading state varies with the type of the service. For example, for the food delivery service, the heading state is a food-fetched state; for the express delivery service, the heading state may be an under-delivery state, and so on.

Optionally, to ensure relatively high control by the deliverer over the delivery service and meet personal needs of the deliverer, in another specific implementation, the preset activation condition may be: an instruction of obtaining prompt information about the target delivery order is received. Specifically, an operating interface may be provided to the deliverer, so that the deliverer can issue, on the operating interface, an instruction of obtaining prompt information about the target delivery order. Further, when the information prompt apparatus runs on a terminal device, if the deliverer issues a prompt information obtaining instruction, the information prompt apparatus may directly receive the prompt information obtaining instruction, thereby determining that the target delivery order meets the preset activation condition. When the information prompt apparatus runs on a server, if the deliverer issues a prompt information obtaining instruction through a terminal device, the terminal device may report the obtained prompt information obtaining instruction to the server. Correspondingly, the information prompt apparatus may obtain the prompt information obtaining instruction, thereby determining that the target delivery order meets the preset activation condition.

It should be emphasized that the preset activation condition is only an example, and shall not constitute a limitation on the embodiments of this application.

S102. Obtain, when the target delivery order meets the preset activation condition, auxiliary information corresponding to an order identifier of the target delivery order.

When the target delivery order meets the preset activation condition, it indicates that it is time to give a prompt of whether to contact the user in advance. Therefore, the auxiliary information corresponding to the order identifier of the target delivery order may be obtained. The auxiliary information is a judgment result that is determined based on an advance contact probability corresponding to the order identifier and that is used to indicate whether to contact the user in advance. The advance contact probability is determined based on a target historical order, and the target historical order is a historical order with the order identifier. In addition, for any delivery order, the order identifier of the delivery order may be a delivery address or a user identifier, or the like.

It should be noted that the server may calculate the advance contact probability corresponding to each order identifier beforehand based on the historical order. In this way, the corresponding advance contact probability can be determined according to the order identifier of the delivery order to be delivered. In addition, the advance contact probability corresponding to each order identifier may be updated regularly to ensure that the advance contact probability is timely and effective.

In specific applications, the server may store the advance contact probability corresponding to each order identifier, or may store the judgment result that corresponds to each order identifier and that is determined based on the advance contact probability. Alternatively, the server may store both the advance contact probability corresponding to each order identifier and the judgment result. All such practices are reasonable. In addition, a specific manner of determining a judgment result corresponding to any order identifier may be: determining whether the advance contact probability corresponding to the order identifier exceeds a preset probability threshold. If the advance contact probability exceeds the preset probability threshold, the judgment result is to contact the user in advance; otherwise, the judgment result is not to contact the user in advance. The preset probability threshold may be set according to an actual situation, and is not limited in this application. For example, the preset probability threshold may be 70%, 80%, 90%, or the like.

Understandably, the auxiliary information may be an advance contact probability, and/or a judgment result determined based on the advance contact probability. In addition, when only the advance contact probability corresponding to each order identifier is stored in the server, and if the auxiliary information is the judgment result corresponding to the advance contact probability, the information prompt apparatus may obtain the advance contact probability from the server, and then determine the judgment result based on the advance contact probability. When only the advance contact probability corresponding to each order identifier is stored in the server, and if the auxiliary information is both the judgment result corresponding to the advance contact probability and the advance contact probability, the information prompt apparatus may obtain the advance contact probability from the server, and then determine a judgment result based on the advance contact probability.

Optionally, in a specific implementation, the obtaining the auxiliary information corresponding to the order identifier of the delivery order may include: obtaining the auxiliary information corresponding to a delivery address of the delivery order. That is, the order identifier of any delivery order is a delivery address.

Correspondingly, a formula for calculating the advance contact probability may be:

$${P}_{i} = \frac{\frac{freq ( {y}_{i} \vert X )}{freq ( X )} \frac{freq ( X )}{freq ( All )}}{P ( Y = {y}_{i} )}$$

where P₁ is an advance contact probability corresponding to a delivery order that has a delivery address i, freq(yᵢ|X) is a quantity of samples that have a record of contacting a user in advance of delivery and that have a delivery address i, freq(X) is a quantity of samples that have a record of contacting a user in advance of delivery among all historical order samples, freq(All) is a quantity of all historical order samples, and P(Y=yᵢ) is a probability of historical order samples with a delivery address i existing in all the historical order samples.

Alternatively, a formula for calculating the advance contact probability may be:

$${P}_{i} = \frac{{N}_{i}}{{M}_{i}}$$

where Pᵢ is an advance contact probability corresponding to a delivery order that has a delivery address i, Mᵢ is a quantity of historical order samples that has a delivery address i, and Nᵢ is a quantity of samples that have a record of contacting a user in advance of delivery among the historical order samples having a delivery address i.

Optionally, in another specific implementation, the obtaining the auxiliary information corresponding to the order identifier of the target delivery order may include: obtaining auxiliary information corresponding to a user identifier of the target delivery order. That is, the order identifier of any delivery order is a user identifier. The user identifier may be a mobile phone number, a user name, or other information that can uniquely identify the user.

Correspondingly, a formula for calculating the advance contact probability may be:

$${P}_{i} = \frac{\frac{freq ( {z}_{i} \vert X )}{freq ( X )} \frac{freq ( X )}{freq ( All )}}{P ( Z = {z}_{i} )}$$

where Pᵢ is an advance contact probability corresponding to a delivery order that has a user identifier i, freq(z₁|X) is a quantity of samples that have a record of contacting a user in advance of delivery and that have a user identifier i, freq(X) is a quantity of samples that have a record of contacting a user in advance of delivery among all historical order samples, freq(All) is a quantity of all historical order samples, and P(Z=z₁) is a probability of historical order samples with a user identifier i existing in all the historical order samples.

Alternatively, a formula for calculating the advance contact probability may be:

$$P = \frac{{E}_{i}}{{F}_{i}}$$

where P₁ is an advance contact probability corresponding to a delivery order that has a user identifier i, F₁ is a quantity of historical order samples that has a user identifier i, and E₁ is a quantity of samples that have a record of contacting a user in advance of delivery among the historical order samples having a user identifier i.

In addition, understandably, means of contact for contacting the user in advance may include: telephone, short message service, instant messaging (IM), or one or more thereof, or the like. Therefore, the means of contact corresponding to the advance contact probability may include: telephone, short message service, instant messaging (IM), or one or more thereof. Further, when the means of contact corresponding to the advance contact probability is telephone, the record of contacting the user in advance of delivery specifically refers to: a record of contacting the user by phone in advance of delivery; when the means of contact corresponding to the advance contact probability is a short message service, the record of contacting the user in advance of delivery specifically refers to: a record of contacting the user through the short message service in advance of delivery; when the means of contact corresponding to the advance contact probability is an IMS message, the record of contacting the user in advance of delivery specifically refers to: a record of contacting the user through an IM message in advance of delivery, and so on.

It should be emphasized that a formula for calculating the advance contact probability is the formula for calculating the advance contact probability corresponding to each order identifier. Moreover, the foregoing formula for calculating the advance contact probability is only an example, and shall not constitute a limitation on the embodiment of this application.

S103. Output, when the auxiliary information meets a preset prompt condition, prompt information used as a prompt of contacting the user in advance.

After obtaining the auxiliary information, the information prompt apparatus may determine whether the auxiliary information meets the preset prompt condition. Further, when the auxiliary information meets the preset prompt condition, the information prompt apparatus may output prompt information used as a prompt of contacting the user in advance; when the auxiliary information does not meet the preset prompt condition, the information prompt apparatus may output prompt information used as a prompt of not contacting the user in advance, or may not output the prompt information.

Optionally, in a specific implementation, in the case that the auxiliary information is the advance contact probability, when the auxiliary information meets the preset prompt condition, the step of outputting prompt information used as a prompt of contacting the user in advance may include:

outputting, when the target advance contact probability is greater than a preset probability threshold, the prompt information used as a prompt of contacting the user in advance.

In this specific implementation, the preset probability threshold may be set according to an actual situation, and is not limited in this application. For example, the preset probability threshold may be 70%, 80%, 90%, or the like. Specifically, the prompt information used as a prompt of contacting the user in advance may be text information or speech information, or the like.

When the prompt information is text information, a specific output form of the prompt information may be a pop-up box, a short message, an IM message, or the like. In addition, on a precondition of ensuring that the prompt information gives an instruction to contact the user in advance, specific content of the prompt information may be set according to an actual situation. For example, the auxiliary information is an advance contact probability 70%, the specific content of the prompt information may be “Please contact the user in advance”, or “The advance contact probability is 70%”, or “The probability of contacting the user in advance is 70%. Please contact the user in advance”, or “Based on the analysis of historical data, the probability of contacting the user in advance is 70%”, or “Based on the analysis of historical data, please contact the user in advance”, or, “Based on the analysis of historical data, the probability of contacting the user in advance by phone is 70%. Please contact the user in advance”, and the like.

When the prompt information is speech information, the prompt information may be a preset prompt tone or a speech message. When the prompt information is a speech message, the speech message may be set according to an actual situation on a precondition of ensuring that the prompt information gives an instruction to contact the user in advance.

Optionally, in another specific implementation, in the case that the auxiliary information is a judgment result determined based on the advance contact probability, when the auxiliary information meets the preset prompt condition, the step of outputting prompt information used as a prompt of contacting the user in advance may include:

outputting, when the judgment result indicates a need to contact the user in advance, the prompt information that is used as a prompt of contacting the user in advance.

In this specific implementation, the prompt information used as a prompt of contacting the user in advance may be text information or speech information, or the like.

When the prompt information is text information, a specific output form of the prompt information may be a pop-up box, a short message, an IM message, or the like. In addition, on a precondition of ensuring that the prompt information gives an instruction to contact the user in advance, specific content of the prompt information may be set according to an actual situation. For example, the auxiliary information is a judgment result “Contact the user in advance”, and the specific content of the prompt information may be “Contact the user in advance”, or “Based on the analysis of historical data, please contact the user in advance”.

When the prompt information is speech information, the prompt information may be a preset prompt tone or a speech message. When the prompt information is a speech message, specific content of the speech message may be set according to an actual situation on a precondition of ensuring that the prompt information gives an instruction to contact the user in advance.

Optionally, in another specific implementation, in the case that the auxiliary information is the advance contact probability and a judgment result determined based on the advance contact probability, when the auxiliary information meets the preset prompt condition, the step of outputting prompt information used as a prompt of contacting the user in advance may include:

outputting, when the advance contact probability is greater than the preset probability threshold or when the judgment result indicates a need to contact the user in advance, the prompt information used as a prompt of contacting the user in advance.

In this specific implementation, the preset probability threshold may be set according to an actual situation, and is not limited in this application. For example, the preset probability threshold may be 70%, 80%, 90%, or the like. Specifically, the prompt information used as a prompt of contacting the user in advance may be text information or speech information, or the like.

When the prompt information is text information, a specific output form of the prompt information may be a pop-up box, a short message, an IM message, or the like. On a precondition of ensuring that the prompt information gives an instruction to contact the user in advance, specific content of the prompt information may be set according to an actual situation. For example, the auxiliary information is an advance contact probability 70%, the judgment result is “Contact the user in advance”, and specific content of the prompt information may be “Contact the user in advance”, or “The probability of contacting the user in advance is 70%”, or “The probability of contacting the user in advance is 70%. Please contact the user in advance”, or “Based on the analysis of historical data, the probability of contacting the user in advance is 70%”, or “Based on the analysis of historical data, please contact the user in advance”, or, “Based on the analysis of historical data, the probability of contacting the user in advance by phone is 70%. Please contact the user in advance”, and the like.

When the prompt information is speech information, the prompt information may be a preset prompt tone or a speech message. When the prompt information is a speech message, specific content of the speech message may be set according to an actual situation on a precondition of ensuring that the prompt information gives an instruction to contact the user in advance.

In addition, when the information prompt apparatus runs on a terminal device, the information prompt apparatus may output the prompt information corresponding to the target delivery order. When the information prompt apparatus runs on a server, the information prompt apparatus may send the auxiliary information to the terminal device, so that the terminal device determines the prompt information based on the auxiliary information and then outputs the prompt information. Of course, the information prompt apparatus may determine the prompt information based on the auxiliary information, and send the prompt information to the terminal device, so that the terminal device directly outputs the prompt information.

In the method according to the embodiment of this application, the judgment result of determining whether to contact the user in advance is obtained based on historical data of the user, without requiring subjective analysis of the deliverer. Therefore, the judgment result is more credible and avoids an analysis process of the deliverer. As can be seen, this solution improves reliability of the judgment result of whether to contact the user in advance and convenience of the delivery process.

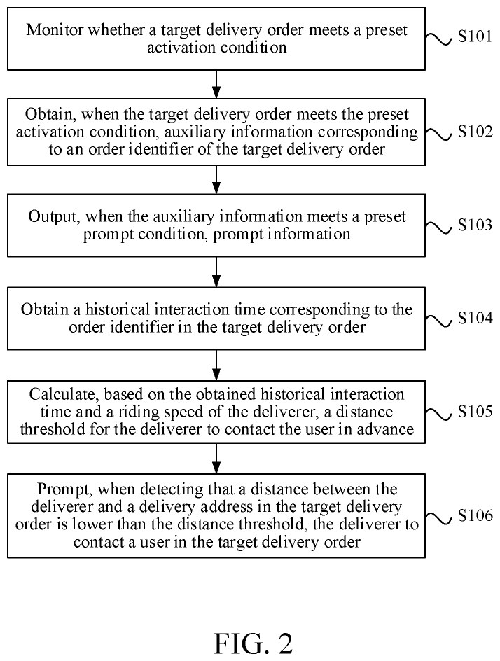

To further prompt the deliverer to contact the user at an appropriate time and improve delivery efficiency of the deliverer, on a precondition that the method includes steps S101 to S103, as shown in FIG. 2, an information prompt method according to an embodiment of this application may further include:

S104. Obtain a historical interaction time corresponding to the order identifier in the target delivery order.

The historical interaction time is an average time required from contacting the user to completing delivery of the delivery order.

S105. Calculate, based on the obtained historical interaction time and a riding speed of the deliverer, a distance threshold for the deliverer to contact the user in advance.

After outputting the prompt information used as a prompt of contacting the user in advance, in order to further prompt the deliverer to contact the user at an appropriate time, the information prompt apparatus may obtain a historical interaction time corresponding to the order identifier in the target delivery order, and then based on the obtained historical interaction time and a riding speed of the deliverer of the target delivery order, calculate a distance threshold for the deliverer to contact the user in advance. Understandably, a displacement may be determined by positioning with a positioning apparatus, and then the riding speed of the deliverer may be determined based on the time information and the displacement. The positioning apparatus may include but is not limited to a Global Positioning System (GPS).

Specifically, a formula for calculating the distance threshold for the deliverer to contact the user in advance may include but is not limited to: S=v×t, where S is the distance threshold, v is the riding speed of the deliverer, and t is the historical interaction time of the user.

In addition, the server may determine the historical interaction time corresponding to each order identifier based on historical data. Then, during an information prompt process, the information prompt apparatus may obtain the historical interaction time corresponding to the order identifier in the target delivery order. In addition, the historical interaction time corresponding to each order identifier may be updated regularly to ensure timeliness.

S106. Prompt, when detecting that a distance between the deliverer and a delivery address in the target delivery order is lower than the distance threshold, the deliverer to contact a user in the target delivery order.

After obtaining the distance threshold, when detecting that the distance between the deliverer and the delivery address in the target delivery order is lower than the distance threshold, the information prompt apparatus may prompt the deliverer to contact the user in the target delivery order. Understandably, the means of contact for the deliverer to contact the user in the target delivery order is the same as the means of contact corresponding to the advance contact probability.

Specifically, when the information prompt apparatus runs on a terminal device, the terminal device may detect, based on a local positioning apparatus, whether a distance between the deliverer and a delivery address in the target delivery order is lower than the distance threshold, and then prompt, when the distance is lower than the distance threshold, the deliverer to contact the user in the target delivery order. When the information prompt apparatus runs on a server, the terminal device may report location information to the server based on the local positioning apparatus. Further, based on the reported location information, the information prompt apparatus may detect whether the distance between the deliverer and the delivery address in the target delivery order is lower than the distance threshold, and then prompt, when the distance is lower than the distance threshold, the deliverer to contact the user in the target delivery order.

The means of prompting the deliverer to contact the user in the target delivery order may be but is not limited to a speech prompt or a text prompt. In addition, for a speech prompt, the content of the prompt may be a preset prompt tone or a speech message. The speech message may include a mobile phone number tail of the user in the target delivery order and an inquiry about whether to make a call. For example, the content of the prompt may be “You are close to a user with a number tail 1024. Will you make a call?”

Further, after prompting the deliverer to contact the user in the target delivery order, the information prompt apparatus may obtain a speech instruction issued by the deliverer. The information prompt apparatus performs, when it is determined that the speech instruction is the preset contact instruction, an operation of contacting the user in the target delivery order; otherwise, ends the process. Automatic contact is performed through speech interaction, thereby reducing operations of the deliverer and improving safety in the delivery process.

It should be emphasized that when the means of contact is a phone number, the performing an operation of contacting the user in the target delivery order may be: dialing the phone number of the user in the target delivery order. When the means of contact is a short message service, the performing an operation of contacting the user in the target delivery order may be: sending a preset inquiry short message to the user in the target delivery order. When the means of contact is an IM message, the performing an operation of contacting the user in the target delivery order may be: sending a preset inquiry IM message to the user in the target delivery order. In addition, the content of a preset contact instruction may be irrelevant to the means of contact, and may be, for example, “Please contact the user”, “Contact the user”, or the like. Of course, the content of the preset contact instruction may also be related to the means of contact. For example, when the means of contact is a phone number, the content of the preset contact instruction may be “Please make a call”, “Contact the user with a call”, or the like. When the means of contact is a short message, the content of the preset contact instruction may be “Send a short message to the user”, “Contact the user by SMS”, or the like. When the means of contact is an IM message, the content of the preset contact instruction may be “Send an IM message to the user”, and so on.

In addition, understandably, when the information prompt apparatus runs on a terminal device, the information prompt apparatus may determine, after obtaining the speech instruction issued by the deliverer, whether the speech instruction is a preset contact instruction. When it is determined that the speech instruction is a preset contact instruction, the information prompt apparatus performs the operation of contacting the user in the target delivery order. When the information prompt apparatus runs on a server, the information prompt apparatus may determine, after obtaining the speech instruction issued by the deliverer, whether the speech instruction is a preset contact instruction. When it is determined that the speech instruction is a preset contact instruction, the information prompt apparatus instructs the terminal device of the deliverer to perform the operation of contacting the user in the target delivery order, so that the operation of contacting the user is performed collaboratively by the terminal device and the server.

As can be seen, this solution improves reliability of the judgment result of whether to contact the user in advance during logistics delivery, and improves convenience in the delivery process. In addition, at the appropriate time, the deliverer is prompted to contact the user, thereby improving delivery efficiency of the deliverer.

The following describes an information prompt method according to an embodiment of this application with reference to a specific embodiment. A means of contact for contacting a user in advance in the specific embodiment is a phone call, and an order identifier is a delivery address.

It should be noted that the information prompt method in this embodiment may be implemented by an information prompt apparatus. The information prompt apparatus runs on a server. In addition, delivery services relating to this embodiment of this application may include, but are not limited to, food delivery and express delivery.

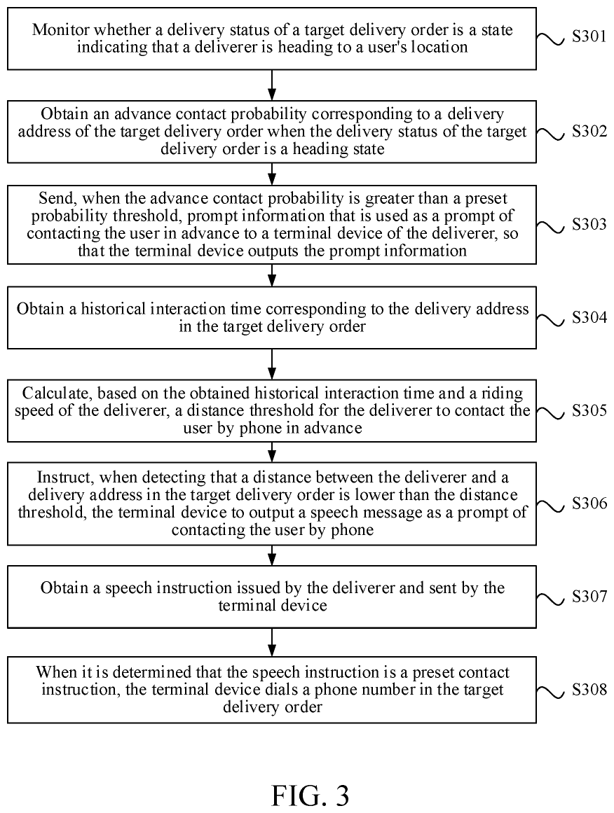

As shown in FIG. 3, an information prompt method may include the following steps:

S301. Monitor whether a delivery status of a target delivery order is a state indicating that a deliverer is heading to a user's location (hereinafter referred to as “heading state”).

The information prompt apparatus is applied to a server, and therefore, the information prompt apparatus can obtain the delivery status that is of the target delivery order and that is reported by a terminal device, so as to monitor whether the delivery status of the target delivery order is a heading state.

The specific form of the heading state varies with the type of the service. For example, for the food delivery service, the heading state is a food-fetched state; for the express delivery service, the heading state may be an under-delivery state, and so on. In addition, the deliverer may update the delivery status of the target delivery order through delivery service client software in the terminal device.

S302. Obtain an advance contact probability corresponding to a delivery address of the target delivery order when the delivery status of the target delivery order is a heading state.

When it is detected that the delivery status of the target delivery order is a heading state, it indicates that it is time to give a prompt of whether to contact the user in advance. Therefore, the advance contact probability corresponding to an order identifier of the target delivery order may be obtained, and then subsequent processing is performed. The advance contact probability is determined based on a target historical order, and the target historical order is a historical order that has the delivery address of the target delivery order.

It should be noted that the server may calculate and store the advance contact probability corresponding to each delivery address beforehand based on the historical order. In this way, the corresponding advance contact probability can be determined according to the delivery address of the delivery order to be delivered. In addition, the advance contact probability corresponding to each delivery address may be updated regularly to ensure that the advance contact probability is timely and effective.

Correspondingly, a formula for calculating the advance contact probability may be:

$${P}_{i} = \frac{\frac{freq ( {y}_{i} \vert X )}{freq ( X )} \frac{freq ( X )}{freq ( All )}}{P ( Y = {y}_{i} )}$$

where P₁ is an advance contact probability corresponding to a delivery order that has a delivery address i, freq(yᵢ|X) is a quantity of samples that have a record of contacting a user by phone in advance of delivery and that have a delivery address i, freq(X) is a quantity of samples that have a record of contacting a user by phone in advance of delivery among all historical order samples, freq(All) is a quantity of all historical order samples, and P(Y=yᵢ) is a probability of historical order samples with a delivery address i existing in all the historical order samples.

S303. Send, when the advance contact probability is greater than a preset probability threshold, prompt information that is used as a prompt of contacting the user in advance to a terminal device of the deliverer, so that the terminal device outputs the prompt information.

After obtaining the advance contact probability, the information prompt apparatus can determine whether the advance contact probability is greater than the preset probability threshold. When the advance contact probability is greater than the preset probability threshold, the information prompt apparatus sends, to the terminal device of the deliverer, the prompt information used as a prompt of contacting the user by phone in advance, so that the terminal device outputs the prompt information.

The preset probability threshold may be set according to an actual situation, and is not specifically limited in this application. For example, the preset probability threshold may be 70%, 80%, 90%, or the like. Specifically, the prompt information used as a prompt of contacting the user in advance may be text information or speech information, or the like.

S304. Obtain a historical interaction time corresponding to the delivery address in the target delivery order.

After sending the prompt information used as a prompt of contacting the user by phone in advance to the terminal device of the deliverer, the information prompt apparatus may obtain the pre-stored historical interaction time corresponding to the delivery address in the target delivery order, and then perform subsequent processing.

S305. Calculate, based on the obtained historical interaction time and a riding speed of the deliverer, a distance threshold for the deliverer to contact the user by phone in advance.

The terminal device may determine a displacement by positioning with a positioning apparatus, and then determine the riding speed of the deliverer based on the time information and the displacement. The positioning apparatus may include but is not limited to a Global Positioning System (GPS). The terminal device may report the determined riding speed to a server. In another embodiment, the terminal device may also report a determined location of the deliverer to the server, and the server determines the displacement, and then determines the riding speed of the deliverer based on the time information and the displacement.

S306. Instruct, when detecting that a distance between the deliverer and a delivery address in the target delivery order is lower than the distance threshold, the terminal device to output a speech message as a prompt of contacting the user by phone.

The terminal device may report location information to the server based on a local positioning apparatus. Further, based on the reported location information, the information prompt apparatus may detect whether the distance between the deliverer and the delivery address in the target delivery order is lower than the distance threshold, and then instruct, when the distance is lower than the distance threshold, the terminal device of the deliverer to output a speech message used as a prompt of contacting the user by phone.

S307. Obtain a speech instruction issued by the deliverer and sent by the terminal device.

After the terminal device outputs the speech message used as a prompt of contacting the user by phone, the deliverer may issue a speech instruction. Correspondingly, the terminal device may collect the speech instruction and report it to the server. In this way, the information prompt apparatus may obtain the speech instruction issued by the deliverer and sent by the terminal device, and perform a subsequent determining process.

S308. When it is determined that the speech instruction is a preset contact instruction, the terminal device dials a phone number in the target delivery order.

The information prompt apparatus may determine whether the speech instruction is a preset contact instruction. When it is determined that the speech instruction is a preset contact instruction, the information prompt apparatus instructs the terminal device to dial the phone number in the target delivery order.

As can be seen, this solution improves reliability of the judgment result of whether to contact the user by phone in advance during logistics delivery, and improves convenience in the delivery process. In addition, at the appropriate time, the deliverer is prompted to contact the user by phone, thereby improving delivery efficiency of the deliverer.

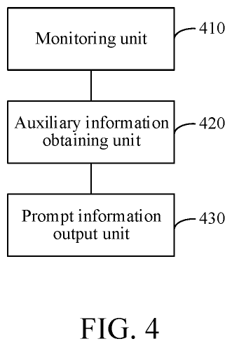

Corresponding to the above method embodiment, an embodiment of this application further provides an information prompt apparatus. As shown in FIG. 4, the information prompt apparatus may include:

a monitoring unit 410, configured to monitor whether a target delivery order meets a preset activation condition;

an auxiliary information obtaining unit 420, configured to obtain, when the target delivery order meets the preset activation condition, auxiliary information corresponding to an order identifier of the target delivery order, where the auxiliary information is determined based on a target advance contact probability corresponding to the order identifier, the advance contact probability is determined based on a target historical order, and the target historical order is a historical order with the order identifier; and

a prompt information output unit 430, configured to output, when the auxiliary information meets a preset prompt condition, prompt information used as a prompt of contacting the user in advance.

In the apparatus according to the embodiment of this application, the judgment result of determining whether to contact the user in advance is obtained based on historical data of the user, without requiring subjective analysis of the deliverer. Therefore, the judgment result is more credible and avoids an analysis process of the deliverer. As can be seen, this solution improves reliability of the judgment result of whether to contact the user in advance and convenience of the delivery process.

Optionally, the prompt information output unit 430 may include:

a first information output subunit, configured to output, when the auxiliary information is the advance contact probability and when the advance contact probability is greater than a preset probability threshold, the prompt information used as a prompt of contacting the user in advance;

or,

a second information output subunit, configured to output, when the auxiliary information is a judgment result determined based on the advance contact probability and when the judgment result indicates a need to contact the user in advance, the prompt information used as a prompt of contacting the user in advance;

or,

a third information output subunit, configured to output, when the auxiliary information is the advance contact probability and a judgment result determined based on the advance contact probability and when the advance contact probability is greater than a preset probability threshold or the judgment result indicates a need to contact the user in advance, the prompt information used as a prompt of contacting the user in advance.

Optionally, the preset activation condition is: a delivery status is a state indicating that a deliverer is heading to the user's location, or an instruction of obtaining prompt information about the target delivery order is received.

Optionally, the auxiliary information obtaining unit 420 may include:

a first information obtaining subunit, configured to obtain, when the target delivery order meets the preset activation condition, auxiliary information corresponding to a delivery address of the target delivery order.

Optionally, when the auxiliary information obtaining unit 420 includes the first information obtaining subunit, a formula for calculating the advance contact probability is:

$${P}_{i} = \frac{\frac{freq ( {y}_{i} \vert X )}{freq ( X )} \frac{freq ( X )}{freq ( All )}}{P ( Y = {y}_{i} )}$$

where Pᵢ is an advance contact probability corresponding to a delivery order that has a delivery address i, freq(yᵢ|X) is a quantity of samples that have a record of contacting a user in advance of delivery and that have a delivery address i, freq(X) is a quantity of samples that have a record of contacting a user in advance of delivery among all historical order samples, freq(All) is a quantity of all historical order samples, and P(Y=yᵢ) is a probability of historical order samples with a delivery address i existing in all the historical order samples.

Optionally, the auxiliary information obtaining unit 420 may include:

a second information obtaining subunit, configured to obtain, when the target delivery order meets the preset activation condition, auxiliary information corresponding to a user identifier of the target delivery order.

Optionally, when the auxiliary information obtaining unit 420 includes the second information obtaining subunit, a formula for calculating the advance contact probability is:

$${P}_{i} = \frac{\frac{freq ( {z}_{i} \vert X )}{freq ( X )} \frac{freq ( X )}{freq ( All )}}{P ( Z = {z}_{i} )}$$

where Pᵢ is an advance contact probability corresponding to a delivery order that has a user identifier i, freq(z₁|X) is a quantity of samples that have a record of contacting a user in advance of delivery and that have a user identifier i, freq(X) is a quantity of samples that have a record of contacting a user in advance of delivery among all historical order samples, freq(All) is a quantity of all historical order samples, and P(Z=z₁) is a probability of historical order samples with a user identifier i existing in all the historical order samples.

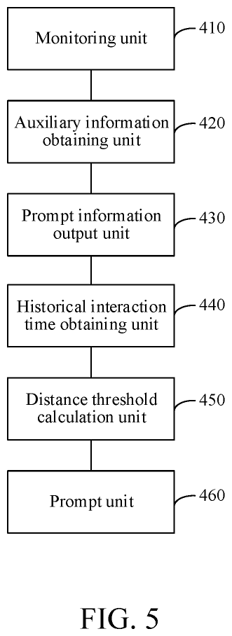

Optionally, as shown in FIG. 5, the information prompt apparatus according to the embodiment of this application may further include:

a historical interaction time obtaining unit 440, configured to obtain a historical interaction time corresponding to the order identifier after the prompt information output unit outputs the prompt information used as a prompt of contacting the user in advance, where the historical interaction time is an average time required from contacting the user to completing delivery of the delivery order;

a distance threshold calculation unit 450, configured to calculate, based on the obtained historical interaction time and a riding speed of the deliverer, a distance threshold for the deliverer to contact the user in advance; and a prompt unit 460, configured to prompt, when detecting that a distance between the deliverer and a delivery address in the target delivery order is lower than the distance threshold, the deliverer to contact a user in the target delivery order.

Optionally, the information prompt apparatus according to the embodiment of this application may further include:

a speech instruction collection unit, configured to obtain, after the prompt unit 460 prompts the deliverer to contact the user in the target delivery order, a speech instruction issued by the deliverer; and

a contact operation performing unit, configured to perform, when it is determined that the speech instruction is a preset contact instruction, an operation of contacting the user in the target delivery order.

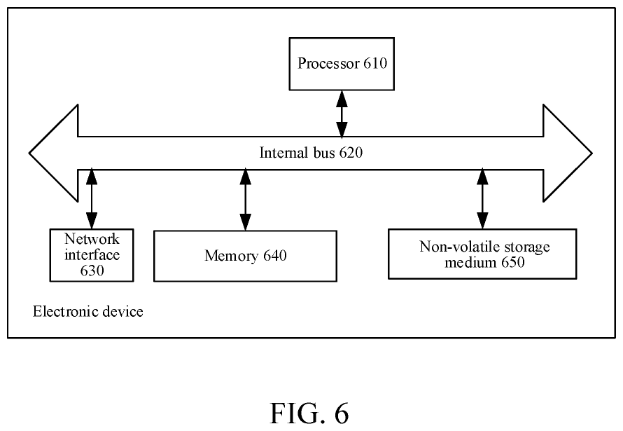

In addition, for the foregoing information prompt method, an embodiment of this application further provides an electronic device. Referring to FIG. 6, at the hardware level, the electronic device includes a processor 610, an internal bus 620, a network interface 630, a memory 640, and a non-volatile storage medium 650, and certainly may further include hardware required for other services. The processor 610 reads a corresponding computer program from the non-volatile storage medium 650 into the memory 640 and then executes the computer program, to perform the information prompt method according to this application, and form an information prompt apparatus at the logic level. Definitely, in addition to a software implementation, this application does not exclude other implementations, for example, a logic device or a combination of software and hardware. In other words, an entity executing the following processing procedure is not limited to the logic units, and may also be hardware or logic devices.

In addition, according to an embodiment of this application, a computer-readable storage medium is further provided. The storage medium stores a computer program. The computer program is configured to perform the foregoing information prompt method.

For details about the implementation processes of the functions and effects of the units in the foregoing apparatus, refer to the implementation processes of the corresponding steps in the foregoing method. Details are not described herein again.

The apparatus embodiment basically corresponds to the method embodiment, and therefore for related parts, reference may be made to partial descriptions in the method embodiment. The described apparatus embodiment is merely an example. The units described as separate parts may or may not be physically separate, and parts displayed as units may or may not be physical units, may be located in one position, or may be distributed on a plurality of network units. Some or all of the modules may be selected according to practical requirements to achieve the objectives of the present invention. A person of ordinary skill in the art may understand and implement the embodiments of this application without creative efforts.

The foregoing descriptions are merely preferred embodiments of this application, but are not intended to limit this application. Any modification, equivalent replacement, or improvement made within the spirit and principle of this application shall fall within the protection scope of this application.

1. An information prompt method, comprising:
monitoring whether a target delivery order meets a preset activation condition;
obtaining, when the target delivery order meets the preset activation condition, auxiliary information corresponding to an order identifier of the target delivery order, wherein the auxiliary information is determined based on an advance contact probability corresponding to the order identifier; and
outputting prompt information when the auxiliary information meets a preset prompt condition.

2. The method according to claim 1, wherein the advance contact probability is determined based on a target historical order, and the target historical order is a historical order with the order identifier.

3. The method according to claim 2, wherein
when the auxiliary information is the advance contact probability, the step of outputting prompt information when the auxiliary information meets a preset prompt condition comprises:
outputting the prompt information when the advance contact probability is greater than a preset probability threshold; and
when the auxiliary information is a judgment result determined based on the advance contact probability, the step of outputting, when the auxiliary information meets a preset prompt condition, prompt information comprises:
outputting the prompt information when the judgment result indicates a need to contact the user in advance; and
when the auxiliary information comprises the advance contact probability and a judgment result determined based on the advance contact probability, the step of outputting, when the auxiliary information meets a preset prompt condition, prompt information comprises:
outputting the prompt information when the advance contact probability is greater than the preset probability threshold or when the judgment result indicates a need to contact the user in advance.

4. The method according to claim 1, wherein the preset activation condition is: a delivery status is a state indicating that a deliverer is heading to the user's location, or an instruction of obtaining prompt information about the target delivery order is received.

5. The method according to claim 1, wherein the order identifier of the target delivery order
is a delivery address of the target delivery order.

6. The method according to claim 5, wherein a formula for calculating the advance contact probability is:
$${P}_{i} = \frac{\frac{freq ( {y}_{i} \vert X )}{freq ( X )} \frac{freq ( X )}{freq ( All )}}{P ( Y = {y}_{i} )}$$
wherein Pᵢ is an advance contact probability corresponding to a delivery order that has a delivery address i, freq(yᵢ|X) is a quantity of samples that have a record of contacting a user in advance of delivery and that have a delivery address i, freq(X) is a quantity of samples that have a record of contacting a user in advance of delivery among all historical order samples, freq(All) is a quantity of all historical order samples, and P(Y=yᵢ) is a probability of historical order samples with a delivery address i existing in all the historical order samples.

7. The method according to claim 1, wherein the order identifier of the target delivery order
is a user identifier of the target delivery order.

8. The method according to claim 7, wherein a formula for calculating the advance contact probability is:
$${P}_{i} = \frac{\frac{freq ( {z}_{i} \vert X )}{freq ( X )} \frac{freq ( X )}{freq ( All )}}{P ( Z = {z}_{i} )}$$
wherein Pᵢ is an advance contact probability corresponding to a delivery order that has a user identifier i, freq(zᵢ|X) is a quantity of samples that have a record of contacting a user in advance of delivery and that have a user identifier i, freq(X) is a quantity of samples that have a record of contacting a user in advance of delivery among all historical order samples, freq(All) is a quantity of all historical order samples, and P(Z=z₁) is a probability of historical order samples with a user identifier i existing in all the historical order samples.

9. The method according to claim 1, wherein means of contact corresponding to the advance contact probability comprise: telephone, short message service, instant messaging (IM), or one or more thereof.

10. The method according to claim 1, further comprises:
obtaining a historical interaction time corresponding to the order identifier after outputting the prompt information, wherein the historical interaction time is an average time required from contacting the user to completing delivery of the target delivery order;
calculating, based on the obtained historical interaction time and a riding speed of the deliverer, a distance threshold for the deliverer to contact the user in advance; and
prompting, when detecting that a distance between the deliverer and a delivery address in the target delivery order is lower than the distance threshold, the deliverer to contact a user in the target delivery order.

11. The method according to claim 10, wherein after the step of prompting the deliverer to contact the user in the target delivery order, the method further comprises:
obtaining a speech instruction issued by the deliverer; and
performing, when it is determined that the speech instruction is a preset contact instruction, an operation of contacting the user in the target delivery order.

12-19. (canceled)

20. A computer-readable storage medium, wherein the storage medium stores a computer program, and the computer program is executable to perform the following steps:
monitoring whether a target delivery order meets a preset activation condition;
obtaining, when the target delivery order meets the preset activation condition, auxiliary information corresponding to an order identifier of the target delivery order,
wherein the auxiliary information is determined based on an advance contact probability corresponding to the order identifier; and
outputting prompt information when the auxiliary information meets a preset prompt condition.

21. An electronic device, comprising a non-volatile storage medium, a processor, and a computer program stored in the non-volatile storage medium and executable on the processor, wherein the processor, when executing the computer program, implements the following steps:
monitoring whether a target delivery order meets a preset activation condition;
obtaining, when the target delivery order meets the preset activation condition, auxiliary information corresponding to an order identifier of the target delivery order, wherein the auxiliary information is determined based on an advance contact probability corresponding to the order identifier; and
outputting prompt information when the auxiliary information meets a preset prompt condition.

22. The electronic device according to claim 21, wherein the advance contact probability is determined based on a target historical order, and the target historical order is a historical order with the order identifier.

23. The electronic device according to claim 22, wherein
when the auxiliary information is the advance contact probability, the processor, when executing the computer program, implements the following step: outputting the prompt information when the advance contact probability is greater than a preset probability threshold;
when the auxiliary information is a judgment result determined based on the advance contact probability, the processor, when executing the computer program, implements the following step: outputting the prompt information when the judgment result indicates a need to contact the user in advance; and
when the auxiliary information comprises the advance contact probability and a judgment result determined based on the advance contact probability, the processor, when executing the computer program, implements the following step: outputting the prompt information when the advance contact probability is greater than the preset probability threshold or when the judgment result indicates a need to contact the user in advance.

24. The electronic device according to claim 21, wherein the order identifier includes a delivery address of the target delivery order.

25. The electronic device according to claim 24, wherein a formula for calculating the advance contact probability is:
$${P}_{i} = \frac{\frac{freq ( {y}_{i} \vert X )}{freq ( X )} \frac{freq ( X )}{freq ( All )}}{P ( Y = {y}_{i} )}$$
wherein Pᵢ is an advance contact probability corresponding to a delivery order that has a delivery address i, freq(yᵢ|X) is a quantity of samples that have a record of contacting a user in advance of delivery and that have a delivery address i, freq(X) is a quantity of samples that have a record of contacting a user in advance of delivery among all historical order samples, freq(All) is a quantity of all historical order samples, and P(Y=yᵢ) is a probability of historical order samples with a delivery address i existing in all the historical order samples.

26. The electronic device according to claim 21, wherein the order identifier includes o a user identifier of the target delivery order.

27. The electronic device according to claim 21, wherein the processor, when executing the computer program, implements the following steps:
obtaining a historical interaction time corresponding to the order identifier, wherein the historical interaction time is an average time required from contacting the user to complete delivery of the historical orders with the order identifier;
calculating, based on the obtained historical interaction time and a riding speed of the deliverer, a distance threshold for the deliverer to contact the user in advance; and
prompting, when detecting that a distance between the deliverer and a delivery address in the target delivery order is lower than the distance threshold, the deliverer to contact a user in the target delivery order.

28. The electronic device according to claim 27, wherein the processor, when executing the computer program, implements the following steps:
obtaining a speech instruction issued by the deliverer; and
performing, when it is determined that the speech instruction is a preset contact instruction, an operation of contacting the user in the target delivery order.
